(19) United States
(12) Patent Application Publication
(10) Pub. No.: US 2006/0159068 A1
(43) Pub. Date: Jul. 20, 2006

(54) Supporting service requests during media data transfer

(75) Inventor: Miikka Lundan, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/040,832

(22) Filed: Jan. 20, 2005

(51) Int. Cl. H04L 12/66

(52) U.S. Cl. 370/352

(57) ABSTRACT

For supporting a service request during a media data transfer session between a media data transfer server and a media player, a media data transfer server generates a service parameter. The service parameter indicates a service type and a location of this service type. The media data transfer server further causes a transfer of the service parameter to the media player. The media player extracts the indication of a service type from a service parameter received from the media data transfer server and causes an advertising of the indicated service type to a user.

### FIELD OF THE INVENTION

The invention relates to methods for supporting a service request during a media data transfer session between a media data transfer server and a media player. The invention relates equally to corresponding software program products. The invention relates moreover to a network element comprising such a media data transfer server, to a user device comprising such a media player and to a communication network comprising such a user device and/or such a network element.

### BACKGROUND OF THE INVENTION

Various user devices allow presenting media content to a user, while the required media data is still being transferred from a service provider to the user device. The media data is usually transferred to this end in a streaming session or using a progressive download. The user device receives the media data and a media player implemented in the user device presents the media content to a user as the media data arrives. Thus, the user does not have to wait until the entire media data has been downloaded. Moreover, the media data does not have to be stored in the user device. Only a small portion has to be buffered in the user device before it is presented, in order to ensure a continuous presentation of the media content.

Such an approach can be used, for example, for enabling a preview and/or a pre-listening of video and/or audio content.

During a preview and/or a pre-listening, a user may want to start some service. The user may desire, for example, to purchase the presented content. Further, the user may desire to communicate with the service provider, for instance in order to give a rating of the presented content. Thus, there is a need for a service provider to advertise the possibility of such kinds of services to a user.

Currently, services are handled completely independently of the data transfer. There can be, for example, separate streaming and buying or rating links in a web-site. This implies, however, that a user has to make use of a browser presenting the web-site, while dealing at the same time with the media player presenting the transferred media data.

### SUMMARY OF THE INVENTION

It is an object of the invention to facilitate a user access to a service while media data is being transferred and presented to the user.

A first method for supporting a service request during a media data transfer session between a media data transfer server and a media player is proposed. The proposed first method comprises at the end of the media data transfer server generating at least one service parameter. The at least one service parameter indicates at least one service type and a location via which the at least one service type can be accessed. The proposed first method further comprises at the end of the media data transfer server causing a transfer of the at least one service parameter to the media player.

The media data transfer session can be for example, though not exclusively, a streaming session or a progressive downloading session.

Moreover, a network element comprising a media data transfer server supporting a service request during a media data transfer session is proposed. The media data transfer server is adapted to generate at least one service parameter, which indicates at least one service type and a location via which the at least one service type can be accessed. The media data transfer server is further adapted to transfer at least one generated service parameter to a media player.

Moreover, a first software program product is proposed, in which a software code for supporting a service request during a media data transfer session between a network element and a media player is stored. When running in a processing unit of the network element, the software code generates at least one service parameter, which indicates at least one service type and a location via which the at least one service type can be accessed. The software code further causes a transfer of the at least one service parameter to a media player.

The media data transfer server of the proposed network element can be any component which supports a transfer of media data to another device. It can be realized in hardware and/or in software. If realized in software, it may correspond for example to the software code stored in the first proposed software program product.

Moreover a second method for supporting a service request during a media data transfer session between a media data transfer server and a media player is proposed. This second method comprises at the media player receiving at least one service parameter from a media data transfer server, the at least one service parameter indicating at least one service type and a location via which the at least one service type can be accessed. The second proposed method further comprises extracting an indication of at least one service type from the at least one received service parameter. The second proposed method further comprises causing an advertising of the at least one indicated service type to a user.

Moreover, a user device comprising a media player supporting a service request during a media data transfer session is proposed. The media player is adapted to receive at least one service parameter from a media data transfer server, the at least one service parameter indicating at least one service type and a location via which the at least one service type can be accessed. The media player is further adapted to extract an indication of at least one service type from the at least one received service parameter. The media player is further adapted to advertise the at least one indicated service type to a user.

Moreover, a second software program product is proposed, in which a software code for supporting a service request during a media data transfer session between a media data transfer server and a user device is stored. When running in a processing unit of the user device, the software code receives at least one service parameter from a media data transfer server, the at least one service parameter indicating at least one service type and a location via which the at least one service type can be accessed. The software code further extracts an indication of at least one service type from the at least one received service parameter. The software code further causes an advertising of the at least one indicated service type to a user.

The media player of the proposed user device can be any component which allows presenting media data, in particular video and/or audio data, to a user. It can be realized in hardware and/or in software. If realized in software, it may correspond to the software code of the second proposed software program product.

Finally, a communication system is proposed which comprises the proposed network element and/or the proposed user device.

The invention proceeds from the consideration that it would be most convenient for a user to access an offered service type during a media data transfer session by means of the media player itself. While conventionally, the data stream between a media data transfer server and a media player comprises only information required for the transfer and the presentation of media content, it is therefore proposed that information about an offered service type is included into this data stream in form of a service parameter. The service parameter includes an indication of the service type, which enables the media player to advertise the service type itself to a user when extracting the service parameter from the data stream. The service parameter includes in addition an indication of the location via which the service type can be accessed, which enables the media player to easily start an offered service type selected by the user.

It is an advantage of the invention that the service parameter enables a user to start a service directly from the media player. There is no need for a user to access the service via a web-page. A link to the data stream from the media data transfer server to the media player is sufficient for enabling the service.

A generated service parameter can be transmitted from the media data transfer server to the media player at various stages.

In one embodiment of the invention, at least one service parameter is transferred to the media player during a setup of a media data transfer session. In this case, the available service types can be advertised to a user from the very beginning of the presentation of the media content, which is represented by the transferred media data.

The at least one generated service parameter may be transferred to the media player on a session level or on a media level, depending on the employed transfer protocol.

The at least one service parameter may comprises for example a Hypertext Transfer Protocol (HTTP) based parameter, a Real Time Streaming Protocol (RTSP) based parameter and a Session Description Protocol based parameter. A service parameter may be defined for example in form of an HTTP or RTSP header which is transmitted on a media level or on a session level. In one alternative, a service parameter may be defined for example in form of an SDP attribute, which is transmitted on a session level. It has to be noted that, in principle, an SDP attribute could also be transmitted on a media level, but some media level attributes are not valid for all types of media content, for example only for video and not for audio.

HTTP has been defined in various IETF specifications. By way of example, Request for Comments 2616: “Hypertext Transfer Protocol—HTTP/1.1”, June 1999 is incorporated by reference herein and referred to for details. RTSP has been defined in IEFT Specification Request for Comments 2326: “Real Time Streaming Protocol (RTSP)”, April 1998, which is incorporated by reference herein and to which it is referred to for details. SDP has been defined in IEFT Specification Request for Comments 2327: “SDP: Session Description Protocol”, April 1998, which is incorporated by reference herein and to which it is referred to for details.

In a further embodiment of the invention, at least one service parameter is transferred to the media player at a later stage than during the session setup. This includes the possibility of sending all service parameters exclusively at a later stage, the possibility of repeating the transmission of at least one service parameter that has already been transmitted during the session setup, and the possibility of sending an additional service parameter during the established session. Sending a service parameter during an ongoing media data transfer session can be realized in particular, though not exclusively, in an RTSP based system.

The option of transmitting a service parameter after the session setup might be of interest, for example, if the presented media content changes during the session, as in the case of a live streaming or broadcasting session. For instance, in a radio type of session, the provided songs are changing constantly. If the media content changes, also the services types which are to be offered might change. In this case, only service parameters indicating some general service types might be indicated during the session setup. Content related service parameters may then be transmitted at an appropriate point of time during the media data transfer session. In a radio type of session, for example, the service provider might offer a buying opportunity anew for every song. Further, the service provider might be interested in a rating opportunity only for certain songs, etc.

As mentioned above, the indication of at least one service type may be extracted at a media player from at least one service parameter and advertised to a user. Upon a user selection of an advertised service type, the media player may send a service request for the selected service type to a location associated in a service parameter to the selected service type. Such a service request may be for example HTTP based or RTSP based.

The offered service types can be any service types which might be of interest to a user during a media data transfer. They may be in particular, though not exclusively, media data related service types, like a purchase or a rating of media content represented by the media data.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of a communication system according to an embodiment of the invention; and

FIG. 2 is a flow chart illustrating an operation in the communication system of FIG. 1.

### DETAILED DESCRIPTION OF THE INVENTION

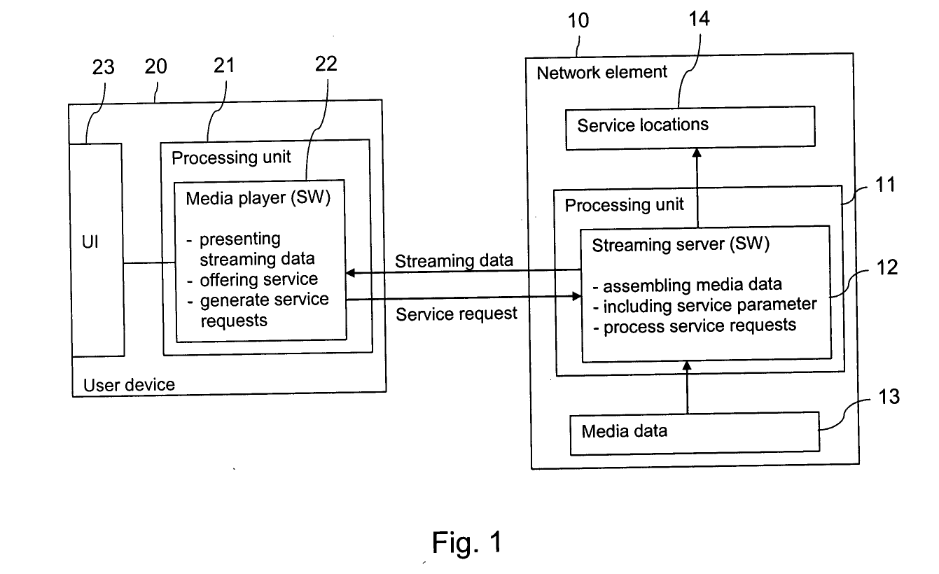

FIG. 1 is a schematic block diagram of a communication system which supports a service request according to an embodiment of the invention;

The system comprises a network element 10 and a user device 20.

The network element 10 is a part of a communication network and supports a service provider in providing media content to users. It comprises a processing unit 11 running a streaming server 12, which is implemented in software. The streaming server 12 functions as a media data transfer server according to the invention. The network element 10 further comprises or has access to a data base 13 storing media data. The network element 10 may further offer or have access to particular service locations 14, via which a respective service type can be started. A location may be linked for example to an application providing a specific service type, and the application is started when the associated location is addressed. Alternatively, an access to particular service locations 14 could be enabled by other elements of the communication network.

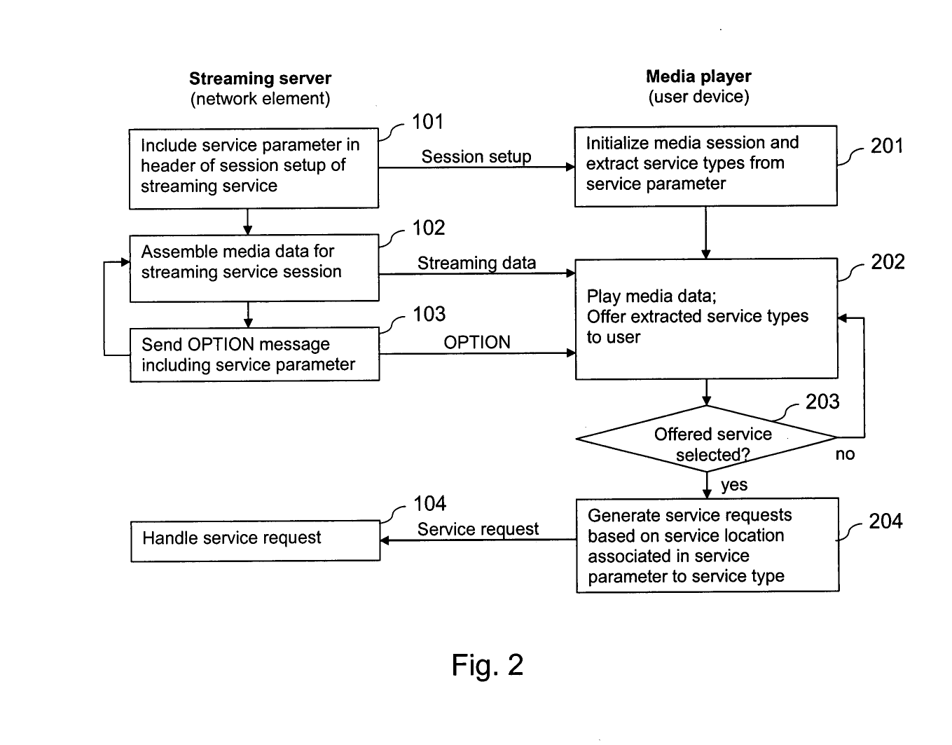

The user device 20 can be for example a mobile terminal or any other electronic device which is able to access the network element 10. The user device 20 comprises a processing unit 21 running a media player 22, which is implemented in software. The media player 20 is able to interact with a user interface 23 of the user device 20. The operation in the communication system of FIG. 1 will now be explained with reference to the flow chart of FIG. 2.

FIG. 2 presents on the left hand side operations performed by the streaming server 12 of the network element 10 and on the right hand side operations performed by the media player 22 of the user device 20.

A user of the user device 20 may request a streaming session from the streaming server 12, for example by calling a corresponding Internet option. (not shown)

During a conventional initial session set-up, the streaming server 12 generates thereupon in addition at least one HTTP header or at least one RTSP header including at least one service parameter for a link in the data stream that advertises a service opportunity. (step 101)

Each service parameter indicates at least one service type and an address. The address describes a location 14 via which the at least one indicated service type can be started. It can be for example an HTTP URL, but equally any other unique address. A single header can be used to describe several service types, if the address of the service types is same. There can also be separate headers for separate service types, if desired by the service provider. If the addresses of several service types are different, a separate header is provided for all service types.

The generated HTTP/RTSP header can have for example the following form:

Service-header = “Service-Ad” “:” “Type” “=”
Service-type “;” “Address” “=” Service-address CRLF
Service-type = “{“ 1#(1*TEXT) ”}”
Service-address = HTTP url or other unique address

“Service-Ad” is the name of the generated header, which indicates that it is used by the streaming server 12 for advertising an available service. The “Service-type” is a text field that describes a service type. It can be, for instance, “purchase” or “rate”. The “Service-address” is a text field that identifies the location of the service.

An exemplary header referring two a purchase service and a rating service at a common service address is:

Service-Ad: Type = {Purchase, Rate}; Address =
HTTP://service.com/

Exemplary headers referring two a purchase service and a rating service at dedicated service addresses are:

Service-Ad: Type = {Rate}; Address =
HTTP://service.com/Rate
Service-Ad: Type = {Purchase}; Address =
HTTP://service.com/Buy

In an alternative embodiment, the streaming server 12 includes each service parameter in an SDP attribute. If an SDP attribute is used, it has to be a session level attribute, not a media level attribute. The above mentioned SDP specification defines that if a client does not understand an attribute, it should be ignored.

A generated SDP attribute can have for example the following form:

a=”Service-Ad” “:” “Type” “=” Service-type “;” “Address”
“=” Service-address CRLF
Service-type = “{“ 1#(1*TEXT) ”}”
Service-address = HTTP url or other unique address

“Service-Ad” is the name of the generated attribute, which indicates that it is used by the streaming server 12 for advertising an available service. “Service-type” and “Service-address” have the same meaning as described above for the HTTP/RTSP header.

An exemplary attribute referring two a purchase service and a rating service at a common service address is:

A=Service-Ad: Type = {Purchase, Rate}; Address =
HTTP://service.com/

The at least one header—or the at least one attribute—generated by the streaming server 12 is transmitted by the network element 10 during the session setup to the user device 20. The user device 20 starts the media player 22, which initializes the streaming session. The initialization includes for example opening a media player window on a display of the user device 20, the display being a part of the depicted user interface 23. In addition, the media player extracts the indication of service types from the received service parameter or parameters. (step 201)

Upon completion of the session setup, the streaming server 12 assembles the media data for the streaming service session and transfers this data to the media player 22 (step 102).

In particular in an RTSP based system, the streaming server 12 can moreover send service parameters during the streaming session. To this end, the streaming server 12 may generate and transmit for example RTSP OPTION messages that include at least one service parameter. (step 103) This at least one service parameter may be the same as the at least one parameter generated in step 101, or at least one newly generated service parameter.

The media player 22 presents the media content represented by the received streaming data via the user interface 23, for example via the opened media player window or via loudspeakers equally forming part of the depicted user interface 23. In parallel, the media player 22 advertises the service types included in the at least one service parameter via the user interface to the user. (step 202) Such a service type may be advertised for example next to static functions of the media player offered in the opened media player window, like a volume control etc. The at least one service parameter may be at least one service parameter extracted from session setup headers or attributes, or at least one service parameter extracted from an OPTION message received during the ongoing streaming session.

The user of the user device 20 may select any offered service type directly from the media player window. Depending on the selected service type, the user may also provide further user input for the selected service type via the user interface 23. When pre-listening to a piece of music, the user may select for example a purchase offer, in order to buy the piece of music. In another example, the user may select a rating option in order to provide a rating for the piece of music to the service provider. In the latter case, the user may select the service type “rate” and input in addition a rating value.

When the media player 22 detects that a user-selected an offered service type via the user interface 23 (step 203), the media player 22 determines the service address associated in the at least one service parameter to the selected service type. Then, the media player 12 generates a service request including this service address and sends the service request to the location 14 which is identified by the service address. (step 204)

The actual service request from the media player 22 can be for example an RTSP message or an HTTP message indicating the determined address. The message can be for instance RTSP OPTIONS, RTSP SET-PARAMETER, HTTP GET or HTTP POST, either comprising the determined address as a URL, for instance:

SET_PARAMETER rtsp://service.com/

For transferring the details of the service request, headers in these RTSP or HTTP messages can be used. To this end, new headers have to be defined. Such a header may be structured for example as follows:

```
Service-header = “Service” “:” “Type” “=” Service-type
  “;” “Identifier” “=” streamIdentifier [“;” “Data” “=”
  Data] CRLF
Service-type = 1#(1*TEXT)
SessionIdentifier = “{“ 1#(1*TEXT) ”}”
Data = 1#(1*TEXT)
```

“Service” is the name of the header. The “Service-type” corresponds to the service type of the service parameter. The “SessionIdentifier” can be any text defined by the service provider. The most convenient identifier is the name of the provided data stream. The “Data” is an optional part of the header and can be any text related to the requested service type.

Exemplary headers for a service request are:

```
Service: Type = Rate; Identifier = {Abba_Waterloo.3gp};
  Data = 4
Service: Type = purchase; Identifier =
  {Abba_Waterloo.3gp}
```

The first header belongs to a service request for a rating of provided media content, by way of example the song “Waterloo” by “ABBA”. The chosen rating is “4”. The second header belongs to a service requests for a purchase of this media content.

In the case of an HTTP based service request, the parameters do not have to be transferred in a dedicated header. Instead, they may be inserted directly into the URL for the selected service type. Examples for the same cases as above are:

http://service.com/streamer.do?Abba_Waterloo.3gp&rate=4
http://service.com/streamer.do?Abba_Waterloo.3gp&purchase

In the network element 10, the service request may be received by the streaming server 12, which handles it by calling the location 14 associated to the indicated service address, possibly taking account of additional information in a header (step 104). It has to be noted, though, that depending on the requested service type, the streaming server 12 does not have to be involved in handling the service request. Instead, the service request may be forwarded, for example by some other element of the communication network, directly to the indicated location.

It is up to service provider to decide whether to use an RTSP based system or an HTTP based system.

On the whole, it becomes apparent that the presented system enables a particularly user-friendly access to media content related service types. A user can request such a service type directly from the media player instead of, for example, from a separate web-page.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for supporting a service request during a media data transfer session between a media data transfer server and a media player, said method comprising at said media data transfer server:
generating at least one service parameter, which at least one service parameter indicates at least one service type and a location via which said at least one service type can be accessed; and
causing a transfer of said at least one service parameter to said media player.

2. The method according to claim 1, wherein said at least one generated service parameter is transferred to said media player during a setup of said media data transfer session.

3. The method according to claim 1, wherein said at least one generated service parameter is transferred to said media player on at least one of a session level and a media level.

4. The method according to claim 1, wherein said at least one service parameter comprises at least one of a Hypertext Transfer Protocol based parameter, a Real Time Streaming Protocol based parameter and a Session Description Protocol based parameter.

5. The method according to claim 1, wherein said at least one generated service parameter is transferred to said media player during said media data transfer session.

6. The method according to claim 1, further comprising at a media player:
extracting an indication of at least one service type from at least one service parameter received from a media data transfer server; and
causing an advertising of said at least one indicated service type to a user.

7. The method according to claim 6, further comprising at said media player upon a user selection of one of said at least one advertised service type:
sending a service request for said selected service type to a location associated in said at least one service parameter to said selected service type.

8. The method according to claim 7, wherein said service request is one of a Hypertext Transfer Protocol based request and a Real Time Streaming Protocol based request.

9. A network element comprising a media data transfer server supporting a service request during a media data transfer session,
wherein said media data transfer server is adapted to generate at least one service parameter, which at least one service parameter indicates at least one service type and a location via which said at least one service type can be accessed; and
wherein said media data transfer server is adapted to transfer at least one generated service parameter to a media player.

10. A communication system comprising a network element according to claim 9.

11. A software program product in which a software code for supporting a service request during a media data transfer session between a network element and a media player is stored, said software code realizing the following steps when running in a processing unit of said network element:
generating at least one service parameter, which at least one service parameter indicates at least one service type and a location via which said at least one service type can be accessed; and
causing a transfer of said at least one service parameter to a media player.

12. A method for supporting a service request during a media data transfer session between a media data transfer server and a media player, said method comprising at said media player:
receiving at least one service parameter from a media data transfer server, said at least one service parameter indicating at least one service type and a location via which said at least one service type can be accessed;
extracting an indication of at least one service type from said at least one received service parameter; and
causing an advertising of said at least one indicated service type to a user.

13. A user device comprising a media player supporting a service request during a media data transfer session,
wherein said media player is adapted to receive at least one service parameter from a media data transfer server, said at least one service parameter indicating at least one service type and a location via which said at least one service type can be accessed;
wherein said media player is adapted to extract an indication of at least one service type from said at least one received service parameter; and
wherein said media player is adapted to advertise said at least one indicated service type to a user.

14. A communication system comprising a user device according to claim 13.

15. A software program product in which a software code for supporting a service request during a media data transfer session between a media data transfer server and a user device is stored, said software code realizing the following steps when running in a processing unit of said user device:
receiving at least one service parameter from a media data transfer server, said at least one service parameter indicating at least one service type and a location via which said at least one service type can be accessed;
extracting an indication of at least one service type from said at least one received service parameter; and
causing an advertising of said at least one indicated service type to a user.
